(19) United States
(12) Patent Application Publication
(10) Pub. No.: US 2006/0242316 A1
(43) Pub. Date: Oct. 26, 2006

(54) Mechanism for transferring data between network nodes

(76) Inventors: Jasmeet Chhabra, Hillsboro, OR (US); Nandakishore Kushalnagar, Portland, OR (US); Lama Nachman, Santa Clara, CA (US); Mark D. Yarvis, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/096,806

(22) Filed: Mar. 31, 2005

(51) Int. Cl. G06F 15/16

(52) U.S. Cl. 709/233

(57) ABSTRACT

According to one embodiment, a method is disclosed. The method includes initiating a transfer of data from a source computer system to a receiving computer system, rebooting the source computer system, receiving a negative acknowledge (Nack) at the source computer system from the receiving computer system and resuming the transfer of data based upon the Nack information.

### FIELD OF THE INVENTION

The present invention relates to computer systems; more particularly, the present invention relates to transmitting data via a network.

### BACKGROUND

Currently, there are various applications that involve the transfer of bulk data across multi-hop wireless networks. One such application includes the transfer of up to 6 Kbytes of data from any individual network node to a central server via cheap and low bandwidth (10-40 kbps) radio links. Problems often occur in such systems in that there may be up to five thousand nodes in the network, where failure of nodes is a relatively common occurrence.

A failure typically results in having to reboot a failed node. Reboots may occur due to hardware failures, or may be triggered by a watchdog in response to a hardware or software lockup. Failures and lockups may lose or corrupt internal protocol states, making resumption of data transfer difficult. However, due to the simple nature of operating systems used in the nodes makes boot-up relatively instantaneous, network protocols should allow a node to quickly resume data transfer after reboot.

Applications have been developed to resume a transfer after reboot (e.g., “wget-c”). However, such applications involve the re-establishment of connections and carrying out a complete transaction from the beginning.

### BRIEF DESCRIPTION OF THE DRAWINGS

The invention is illustrated by way of example and not limitation in the figures of the accompanying drawings, in which like references indicate similar elements, and in which:

FIG. 1 illustrates one embodiment of a network;

FIG. 2 is a block diagram of one embodiment of a computer system; and

FIG. 3 is a flow diagram for one embodiment for transmitting data from a transmitting device to a receiving device.

### DETAILED DESCRIPTION

A method for transmitting data to between a source node and a receiving node upon a failure at the source device is described. The method includes a reboot occurring at the source device due to a failure. It is subsequently determined whether a Negative Acknowledge (Nack) has been received at the source device from the receiving device. If the Nack is received, the source device continues to transmit data stored in a non-volatile memory where it left off prior to having to reboot.

In the following detailed description of the present invention, numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, control processing units (CPUs),

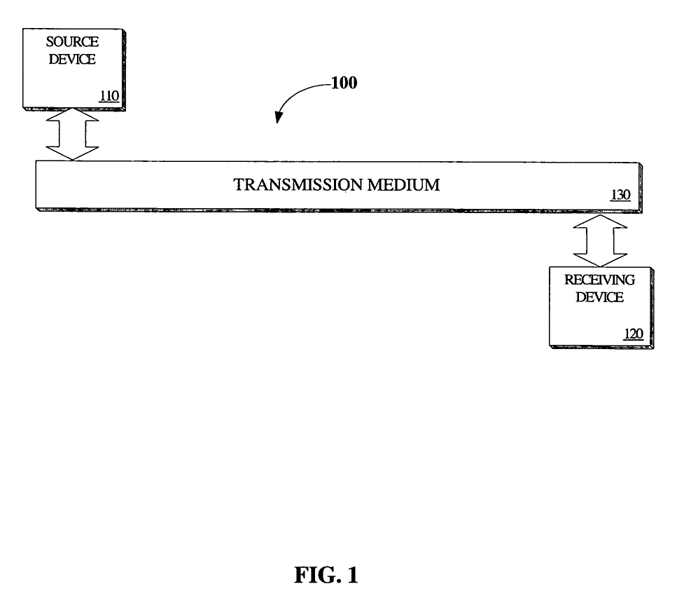

FIG. 1 illustrates one embodiment of a network 100. Network 100 includes a computer system 110 and a computer system 120 coupled via a transmission medium 130. In one embodiment, computer system 110 operates as a source device that transmits data to computer system 120, operating as a receiving device. The data may be, for example, a file, programming data, an executable, or other digital objects. The data is sent via data transmission medium 130. Data transmission medium 130 may be one of many mediums such as an internal network connection, an Internet connection, or other connections. Transmission medium 130 may be connected to a plurality of routers (not shown) and switches (not shown). Note that in other embodiments, data transmission medium 130 is implemented as a wireless over the air (OTA) link

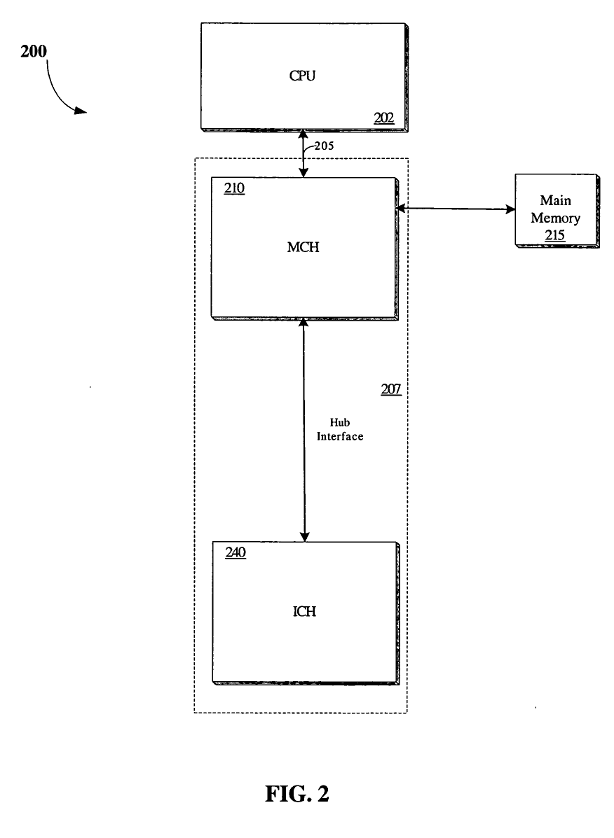

FIG. 2 is a block diagram of one embodiment of a computer system 200. Computer system 200 may be implemented as computer system 110 or computer system 120 (both shown in FIG. 1). Computer system 200 includes a central processing unit (CPU) 202 coupled to bus 205. A chipset 207 is also coupled to bus 105. Chipset 207 includes a memory control hub (MCH) 210. MCH 210 may include a memory controller 212 that is coupled to a main system memory 215. Main system memory 215 stores data and sequences of instructions that are executed by CPU 202 or any other device included in system 200.

In one embodiment, main system memory 215 includes dynamic random access memory (DRAM); however, main system memory 215 may be implemented using other memory types. For example, in some embodiments, main system memory 215 may be implemented with a non-volatile memory.

devices may also be coupled to bus 205, such as multiple CPUs and/or multiple system memories. MCH 110 is coupled to an input/output control hub (ICH) 240 via a hub interface. ICH 240 provides an interface to input/output (I/O) devices within computer system 200.

As discussed above, the failure of a source device transmitting data to a receiving device may cause the source device to have to be rebooted, therefore causing data to potentially be lost or corrupted. According to one embodiment, a stateless mechanism is disclosed that enables bulk data transfers across device reboots and failures. Such a mechanism leverages the fact that bulk data transfers are performed in one direction (e.g., from a source device 110 to a receiving device 120). In such an embodiment, the source component on the protocol is stateless, while the receiving device maintains the state, thus allowing the source device to continue to transfer data after a failure.

In one embodiment, a Transaction ID identifies a connection established to transfer data between a source device and a receiving device. After a connection is established the data is transferred using a Negative Acknowledge (Nack) based sliding window protocol. In such an embodiment, the Nack includes a bitmap that provides information of fragments received during the current window.

According to one embodiment, data to be transferred by the source device is captured at a non-volatile memory device (e.g., main memory 215) at the source device so that contents are not lost across reboots. As discussed above, the state and other information about open connections is maintained at the receiving device. This information includes the Transaction ID for the connection, received fragments, received fragment window (e.g., bitmap that keeps track of fragments that have been received), and the starting fragment of the current window.

The source device maintains, in the non-volatile memory device, the data it needs to transfer for the active connection(s). In one embodiment, the source device is able to regain the state from the Nack when a subsequent Nack is received. At the end of a data transfer an Ack is transmitted by the receiving device to indicate the connection is to be closed. Thus, the source device may erase the data from the previous connection from the non-volatile memory so that a new connection may be established.

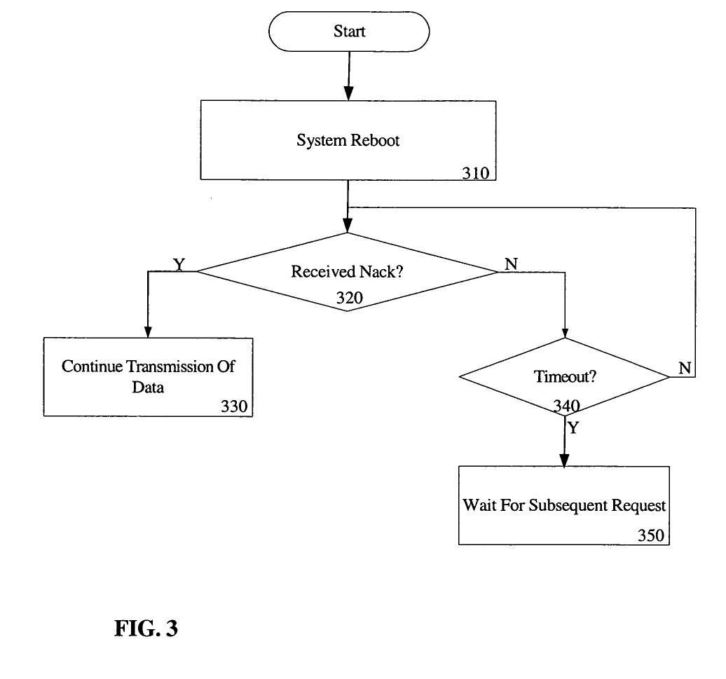

FIG. 3 is a flow diagram illustrating the operation of a source device across reboots at the source device. At processing block 310 a reboot occurs at the source device. At decision block 320, it is determined whether a Nack has been received at the source device from the receiving device. If the Nack is received the source device continues to send data where it left off prior to reboot, processing block 330.

If the Nack has not been received, it is determined whether a Nack wait timeout has occurred, decision block 340. If a timeout has not occurred, control is returned to decision block 320 where it is again determined whether the Nack has been received. If a timeout has occurred, the source device waits for the next data capture/transmit request.

The above-described mechanism enables the dividing of the state of a unidirectional transport protocol across a reliable receiver and an unreliable transmitter so that the sender maintains a soft state and can easily recover from a failure.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method comprising:
initiating a transfer of data from a source computer system to a receiving computer system;
rebooting the source computer system;
receiving a negative acknowledge (Nack) at the source computer system from the receiving computer system; and
resuming the transfer of data based upon the Nack information.

2. The method of claim 1 further comprising determining at the source computer system after the reboot if the Nack has been received.

3. The method of claim 2 further comprising determining if a Nack timeout has occurred at the source computer system if the Nack has not been received.

4. The method of claim 3 further comprising the source computer system waiting to receive a command to initiate a second transfer of data if a Nack timeout has occurred.

5. The method of claim 1 further comprising establishing a connection between the source computer system and the receiving computer system prior to initiating the transfer of data.

6. A computer system comprising:
a non-volatile memory to capture data to be transmitted to a server computer after a reboot of the computer system has occurred; and
a central processing unit (CPU) to initiate a stateless transfer of the data to the server computer.

7. The computer system of claim 6 wherein a connection is established between the computer system and the server computer prior to the transfer of data, wherein the server computer maintains the information for the connection.

8. The computer system of claim 7 wherein the connection is identified by a Transaction Id.

9. The computer system of claim 7 wherein the computer system receives a negative acknowledge (Nack) from the server computer after the reboot.

10. The computer system of claim 9 wherein the Nack includes a bitmap to provide information regarding the connection between the computer system and the server computer.

11. The computer system of claim 10 wherein the bitmap includes an indication of the data received at the server computer from the computer system prior to the reboot.

12. The computer system of claim 10 wherein the Nack includes the Transaction Id.

13. The computer system of claim 7 wherein the computer system regains the state of the transfer of data from information included in the Nack.

14. The computer system of claim 6 wherein the computer system receives an acknowledge (Ack) from the server computer once the transfer of data has been completed.

15. The computer system of claim 14 wherein the non-volatile memory is erased in response to receiving the Ack.

16. An article of manufacture including one or more computer readable media that embody a program of instructions, wherein the program of instructions, when executed by a processing unit, causes the processing unit to perform the process of:
initiating a transfer of data from a source computer system to a receiving computer system;
rebooting the source computer system;
receiving a negative acknowledge (Nack) at the source computer system from the receiving computer system; and
resuming the transfer of data based upon the Nack information.

17. The article of manufacture of claim 16 wherein the program of instructions, when executed by a processing unit, further causes the processing unit to perform the process of determining at the source computer system after the reboot if the Nack has been received.

18. The article of manufacture of claim 17 wherein the program of instructions, when executed by a processing unit, further causes the processing unit to perform the process of determining if a Nack timeout has occurred at the source computer system if the Nack has not been received.

19. The article of manufacture of claim 18 wherein the program of instructions, when executed by a processing unit, further causes the processing unit to perform the process of waiting to receive a command to initiate a second transfer of data if a Nack timeout has occurred.

20. The article of manufacture of claim 16 wherein the program of instructions, when executed by a processing unit, further causes the processing unit to perform the process of establishing a connection between the source computer system and the receiving computer system prior to initiating the transfer of data.

21. A system for wireless communications comprising:
a non-volatile memory to capture data to be transmitted to a server computer after a reboot of the computer system has occurred; and
a central processing unit (CPU) to initiate a stateless transfer of the data to the server computer;
a transceiver assembly communicatively coupled to the CPU to broadcast the data over a wireless link to the server; and
at least one dipole antenna coupled to the transceiver to radiate the broadcast in the form of electromagnetic waves.

22. The computer system of claim 21 wherein a connection is established between the computer system and the server computer prior to the transfer of data, wherein the server computer maintains the information for the connection.

23. The computer system of claim 22 wherein the connection is identified by a Transaction Id.
